(19) United States
(12) Patent Application Publication
(10) Pub. No.: US 2026/0086733 A1
(43) Pub. Date: Mar. 26, 2026

(54) COMMUNICATIONS PROTOCOL CONVERSION OVER A MESH INTERCONNECT

(71) Applicant: Akeana, Inc., Santa Clara, CA (US)

(72) Inventors: Ali Shair Khan, Punjab (PK); Madhavi Kondapaneni, Cupertino, CA (US)

(73) Assignee: Akeana, Inc., Santa Clara, CA (US)

(21) Appl. No.: 19/339,390

(22) Filed: Sep. 25, 2025

Related U.S. Application Data
(60) Provisional application No. 63/699,245, filed on Sep. 26, 2024.
(60) Provisional application No. 63/702,192, filed on Oct. 2, 2024.
(60) Provisional application No. 63/714,529, filed on Oct. 31, 2024.
(60) Provisional application No. 63/719,841, filed on Nov. 13, 2024.
(60) Provisional application No. 63/730,997, filed on Dec. 12, 2024.
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.
(60) Provisional application No. 63/797,195, filed on Apr. 30, 2025.
(60) Provisional application No. 63/803,977, filed on May 12, 2025.
(60) Provisional application No. 63/831,282, filed on Jun. 27, 2025.
(60) Provisional application No. 63/844,802, filed on Jul. 16, 2025.
(60) Provisional application No. 63/854,877, filed on Jul. 31, 2025.
(60) Provisional application No. 63/870,916, filed on Aug. 27, 2025.

(51) Int. Cl. G06F 3/06

(52) U.S. Cl. CPC G06F 3/0655; G06F 3/0604; G06F 3/0673

(57) ABSTRACT

A system-on-chip (SoC) is accessed. The SoC includes a mesh network and one or more coherency ordering agents (COAs). The COAs coordinate coherency for one or more processors coupled to the mesh network. The COAs are coupled to one or more communication converters (CCs) by the mesh network. A processor sends a request to a target device. The request is based on a first communications protocol and includes a memory address. The request is sent by a COA to a CC. A request queue within the CC stores the request. The request is checked against one or more additional requests. The CC translates the request, resulting in a converted request, based on a second communications protocol. The translating is based on the checking. The CC transmits the converted request to the target device.

### RELATED APPLICATIONS

This application claims the benefit of U.S. provisional patent applications “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, and “In-Order Multithreading With Pipeline Flush And Instruction Replay” Ser. No. 63/870,916, filed Aug. 27, 2025.

Each of the foregoing applications is hereby incorporated by reference in its entirety.

### FIELD OF ART

This application relates generally to data sharing and more particularly to communications protocol conversion over a mesh interconnect.

### BACKGROUND

Computer processors are found in electronic devices widely used throughout society. Processors have revolutionized how people work, play, communicate, and access information. Processors underpin personal computing devices to enable internet browsing, application execution, content access, data processing, and communication. The processors are embedded in smart devices to enable connectivity and data processing. The processors collect, analyze, and transmit data in support of automation, remote monitoring, and control of systems. Electronic devices enable communication and networking technologies, facilitating data transmission and network management. The processors are used in telecommunications applications, thus providing seamless connectivity and communication. The processors are present in a wide array of consumer electronics beyond computers and smartphones. The processors enable advanced features, user interfaces, and connectivity options in these consumer devices. Processor versatility, scalability, and computational power have transformed industries, driven innovation, and promoted technological advancements in numerous domains.

The foremost processor categories include Complex Instruction Set Computer (CISC) types and Reduced Instruction Set Computer (RISC) types. A CISC processor instruction can execute a wide variety of operations. The operations can include loading data from and storing data to memory, arithmetic operations, logical operations, and so on. In a RISC processor, the instruction sets are smaller than the CISC instruction sets and typically execute several operations in a pipelined manner. Pipeline stages can include fetch, decode, and execute stages. Each of these pipeline stages can operate in one clock cycle. Thus, the pipelined operation can allow RISC processors to operate on more than one instruction per clock cycle, thereby improving performance.

Computer processors based on integrated circuits (ICs), or “chips,” are designed using a Hardware Description Language (HDL). HDLs support the operation of computer processors using code which can include behavioral, register transfer, gate, and switch level logic. This support enables designers to define system levels with varying detail. Behavioral level logic allows for a set of instructions executed sequentially, while register transfer level logic allows for the transfer of data between registers, based on an explicit clock and gate level logic. An HDL can be used to create text models that describe or express logic circuits. The models are processed by a synthesis program, followed by a simulation or emulation program, to test the logic design. The process can include Register Level Transfer (RTL) abstractions that define the synthesizable data that is fed into a logic synthesis tool. The tool creates the gate-level abstraction of the design that is used for downstream implementation operations. The HDL tools enable the design and implementation of processors, and other integrated circuits such as System-on-Chip (SoC) integrated circuits. SoC ICs are highly versatile and find applications in a wide range of electronic devices and systems. These ICs are designed to incorporate multiple components and functionalities onto a single chip, making them compact, power efficient, and cost effective. Processor performance enables a wide variety of applications, including data processing, virtualization, content creation, and security applications, among others. Processor performance continues to be an important factor in the development of new systems and technologies.

### SUMMARY

The capabilities and utility of devices that contain one or more processors are directly impacted by the performance of the one or more processors. The devices include widely available mobile and handheld devices, wearable devices, consumer electronics, automotive electronics, edge computing, and Internet of Things (IoT), to name a mere few. The processors can be classified based on their instruction sets. The instruction sets broadly include complex instruction sets (CISC) or reduced instruction sets (RISC). The instructions of either type, whether complex or reduced, can generate requests. The requests are sent to target devices such as memory controllers and input/output (I/O) interfaces. The requests include memory access requests such as read requests and write requests, and I/O requests such as receiving data and sending data via an I/O channel. The requests as sent by the processor can use a first communications protocol such as a coherent communications protocol. However, the target devices communicate using a different communications protocol such as a non-coherent communications protocol. Thus, in order to enable the requests to be received, and responses to the requests to be sent, requests must be converted from a first communications protocol to a second communications protocol. Once converted, the requests can be processed by the target devices and responses can be generated. However, the responses use the second communications protocol. Thus, the responses are converted from the second communications protocol to the first communications protocol so that the responses can be sent to the requesting processors.

A system-on-chip (SoC) as described herein includes a mesh network, one or more processors coupled to the mesh network, and one or more coherency ordering agents (COAs). The COAs are coupled to one or more communication converters (CCs) that can convert requests and can convert responses to the requests between communications protocols. Any of the processors can generate a request that is sent to a target device. Each request includes a memory address. Since any processor can generate a request, more than one request generated by any of the processors can be sent to the same target address. Thus, a coherency issue can exist, where data read requests and data write requests can interfere with each other, resulting in access hazards. The requests can be stored in a request queue within a CC. The CCs can check for older pending write requests to the same memory address. When older pending write requests exist, the pending write requests can receive responses from the target device in the order in which the write requests were generated. Further, read requests can be coordinated with the write requests. The coordinating read and write requests ensures that data needed by a read request is not overwritten before a write occurs, and that new data is written in time to prevent reading of stale or invalid data.

A processor-implemented method for sharing data is disclosed comprising: accessing a system-on-chip (SoC), wherein the SoC includes a mesh network and one or more coherency ordering agents (COAs), wherein the one or more COAs coordinate coherency for one or more processors coupled to the mesh network, and wherein the one or more COAs are coupled to one or more communication converters (CCs) by the mesh network; sending, by a processor within the one or more processors, a request to a target device, wherein the request is based on a first communications protocol, wherein the request includes a memory address, and wherein the request is sent, by a COA within the one or more COAs, to a CC within the one or more CCs; storing the request, by a request queue, wherein the request queue is within the CC; checking the request, wherein the checking is based on one or more additional requests; translating, by the CC, the request, wherein the translating results in a converted request, wherein the converted request is based on a second communications protocol, and wherein the translating is based on the checking; and transmitting, by the CC, the converted request to the target device. In embodiments, the checking includes searching for an older pending write request to the memory address. Some embodiments comprise adding the request to a response queue, wherein the adding is based on the searching. Some embodiments comprise collecting, by the CC, from the target device, a response, wherein the response is responsive to the converted request. Some embodiments comprise transforming the response, wherein the transforming results in a converted response, wherein the converted response is based on the first communications protocol.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a communications protocol conversion over a mesh interconnect.

FIG. 2 is a flow diagram for sending a response.

FIG. 3 is a block diagram for a multicore processor.

FIG. 4 is a block diagram for a pipeline.

FIG. 5 is a block diagram of a mesh network.

FIG. 6 is a block diagram of a compute coherency block (CCB).

FIG. 7 is a block diagram of a switching unit.

FIG. 8 is a first block diagram of a communication converter.

FIG. 9 is a second block diagram of a communication converter.

FIG. 10 is a system diagram for a communications protocol conversion over a mesh interconnect.

### DETAILED DESCRIPTION

Techniques for communications protocol conversion over a mesh interconnect are disclosed. A request is sent by a processor within one or more processors in a mesh network to a target device. The target device can include a memory, an I/O interface, and so on. The request can be based on a first communications protocol which can differ from the communications protocol used by the target device. In order for the target device to be able to process the request, the request is translated from the first communications protocol to a second communications protocol. The communications protocols can include different, incompatible protocols. For example, the first communications protocol can be a coherent communications protocol, and the second communications protocol can be a non-coherent communications protocol. The target device can provide a response to the request. In addition to translating between the communications protocols, the ordering of requests from the one or more processors in the mesh network must be coordinated. The ordering or controlling of the sending of the processor requests to the target device is necessitated by the need to maintain data coherency. The need to maintain data coherency arises because each request includes a memory address, and more than one request can target the memory address. As a result, the memory addresses associated with the request must be checked to determine whether an earlier request targeted the same memory address. If the request is to read or load the contents of a memory address, the read must take place before the contents are overwritten with new data. If not, a write-before-read memory hazard can occur. If the request is to write or store data to a memory address, the write must also occur in the correct sequence. If not, the write-before-read hazard as described can occur by overwriting valid, needed data, or another hazard such as a write-after-read hazard. In the latter hazard, the contents of the memory location are read too soon, resulting in reading stale or invalid data.

The conversion of communications protocols over a mesh network can be accomplished by providing extensions such as atomic operation extensions for a processor architecture. The atomic operation extensions can include communications protocol conversion extensions. The instructions can be split into a series of micro-operations, and the series of micro-operations can be executed. By executing the series of micro-operations atomically, the micro-operations appear to execute “all at once.” The atomic execution of the micro-operations enables communications protocol conversion over a mesh interconnect. The micro-operations can include a variety of operations that support the communications protocol conversion. The micro-operations can include a plurality of operations that support the communications protocol conversions of requests sent by a processor to a target device. The micro-operations can enable checking for older pending write requests to a memory address, translating a request between communications protocols, storing a request in a request queue, sending the translated request to the target device, and so on. The micro-operations can further include enqueueing responses, matching an enqueued response using a content addressable memory (CAM), sending the response to the correct processor, and the like.

Data is routinely transferred between nodes within a system such as an SoC. The data can be transferred through common storage such as a system memory, through I/O devices, and so on. The nodes can be executing processes, tasks, etc., where data dependencies can exist between tasks. In a usage example, task B requires data that can be generated by task A, while task C does not have a data dependency with task A. Thus, task A must be executed prior to execution of task B, while task C can be executed in parallel with task A. The data can be transferred between nodes by writing data generated by a first task to one or more addresses in memory, then reading by a second task the data that was stored. The reading and writing are based on tasks sent by processors to a target device such as the system memory. The SoC can include multiple devices which can operate with different protocols, complicating the reading and writing process. Further, there is a need for the data dependencies such as the dependencies just described to be maintained or “coherent” during these reads, meaning read operations and write operations must be coordinated.

A communication converter (CC) is disclosed which can coordinate communication between nodes of the SoC which can operate with different protocols. Further, the CC can coordinate read requests and write requests by storing the requests in a queue, where the queue can be implemented using a FIFO. Write requests are checked against older, pending write requests to the same memory address. The checking write requests against older pending write requests can maintain memory coherency by enabling the write requests to be processed in a proper order. Since the target device such as the memory system can use a different communications protocol from the processor sending the request, the request can be translated from a first communications protocol to a second communications protocol. The request can be processed, and a response generated by the target device can be returned. The response can be checked against the requests, and the response can be sent back to the requesting processor.

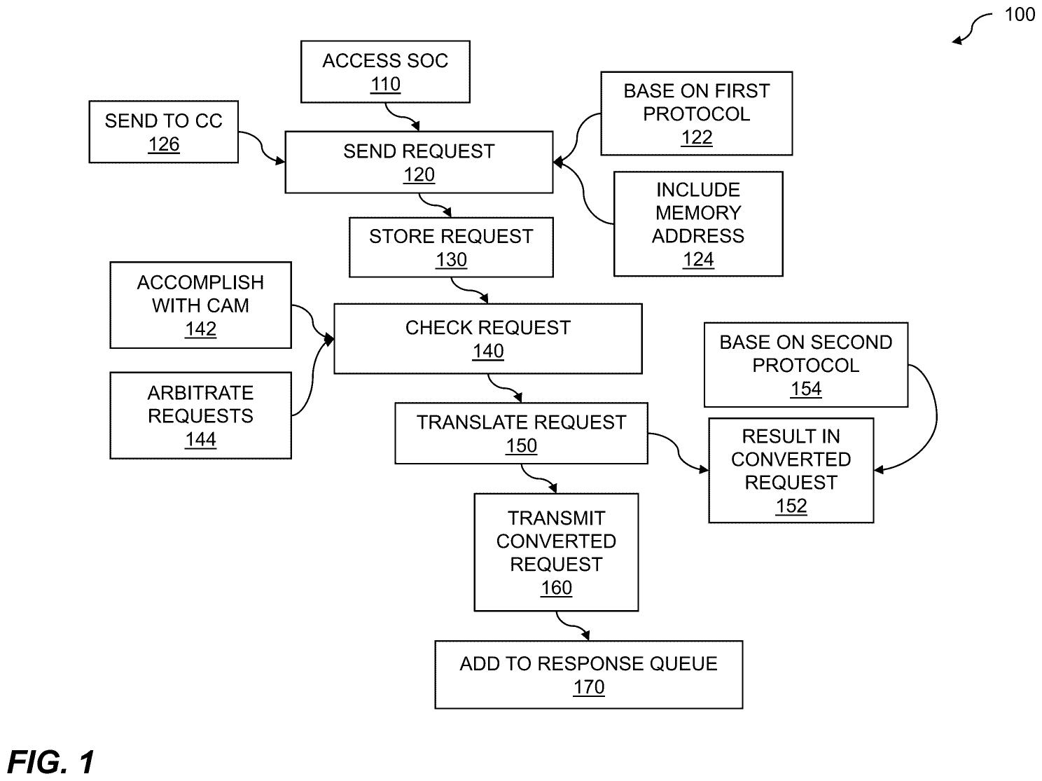

FIG. 1 is a flow diagram for a communications protocol conversion over a mesh interconnect. The flow 100 includes accessing a system-on-chip (SoC) 110. The SoC can include a variety of elements. In embodiments, the SoC includes a mesh network and one or more coherency ordering agents (COAs). The mesh network can enable communication between and among nodes or switching units (SUs) within the mesh network. The communication between SUs can include nearest neighbor communications and can include communication in cardinal directions such as north, south, east, and west. In embodiments, the one or more COAs coordinate coherency for one or more processors coupled to the mesh network. The coherency for the one or more processors can include coordinating read operations and write operations to memory so that valid data is available for reading, and that written data is available for reading when the data is needed for processing. In embodiments, the one or more COAs are coupled to one or more communication converters (CCs) by the mesh network. The CCs can convert between communications protocols. The communications protocols can be substantially different from each other. The communications protocols can include standard communications protocols, SoC-specific protocols, and so on.

The flow 100 includes sending, by a processor within the one or more processors, a request 120 to a target device. A request can include a request to access storage such as a cache, shared cache, or system memory; an I/O device; and so on. In embodiments, the request can be a read request. The read request can read or load data from a memory device, an I/O device, and the like. In other embodiments, the request can be a write request. The write request can write or store data to a memory device or an I/O device. In the flow 100, the request is based on a first communications protocol 122. A communications protocol can include a coherent protocol, a non-coherent protocol, etc. In embodiments, a first communications protocol can include a coherent protocol. A coherent protocol, such as MESI, MOESI, AMBA™, Coherency Extensions (ACE™), AMBA™ Coherent Hub Interface (CHI™), and so on, can enable caches within one or more processor cores to share data within a common memory structure without memory loss. In embodiments, the first communications protocol can include an AMBA™ CHI™ protocol. In the flow 100, the request includes a memory address 124. The memory address can be associated with a local memory, a shared memory address such as a shared cache address, a shared system memory address, etc. The memory address can be unique within the SoC, a system in which the SoC operates, and so on. In the flow 100, the request is sent 126, by a COA within the one or more COAs, to a CC within the one or more CCs. The CC can accomplish a conversion from a first communications protocol to a second communications protocol.

The flow 100 includes storing the request 130, by a request queue, wherein the request queue is within the CC. The storing can be accomplished using local storage within the CC, shared storage, and so on. In embodiments, the storing can be accomplished using a first-in first-out (FIFO) element. As additional requests are received, the additional requests can be stored in the FIFO in the order in which the requests were received. The flow 100 includes checking the request 140. The checking is based on one or more additional requests. When the first communications protocol is a coherent protocol such as AMBA™ CHI™, the one or more additional requests can comprise an older pending write request to the memory address. Since a processor can include a multiprocessor, more than one request can be received from a multiprocessor. In addition, requests can be generated by more than one processor within the SoC, or from another coupled SoC. The requests can include read requests and write requests.

More than one request can access the same memory address. Since a write request can change the contents of a memory address, write requests must be ordered so that the data is written in the proper order. Further, since the write requests change the contents of the memory address, read requests to the memory address must access valid data. Invalid data can include stale data (e.g., data that can be old and in need of replacement), or data that is “too new” that overwrote data that was required by the read operation. In the flow 100, the checking is accomplished with a content addressable memory (CAM) 142. The CAM can compare data such as input search data against stored data, where the stored data is stored in a table. Here, the search data can include a memory address, and the table can include previously requested memory addresses. Further embodiments can include adding the request to a response queue, wherein the adding is based on the checking. The response queue can be used to direct responses to a request to the processor that generated the request.

When the first communications protocol is a protocol such as AMBA™ AXI™ or AMBA™ AXI™ ACE™, the one or more additional requests can comprise another read or write request. For example, a request such as a read request can be generated on a read channel. An additional request, such as a write request, can be requested on a separate write channel. These two channels can be merged to a single request channel when converting to another protocol such as AMBA™ CHI™. In a case such as this, the checking can include arbitrating between requests 144. In embodiments, the first communications protocol comprises an AMBA™ AXI™ protocol. In further embodiments, the second communications protocol comprises an AMBA™/CHI™ protocol. In some embodiments, the checking includes arbitrating between the request and the one or more additional requests.

The flow 100 includes translating, by the CC, the request 150. The request can be translated from between communications protocols. In the flow 100, the translating results in a converted request 152. The translating the request can include converting the request from a coherent protocol (such as CHI) to a non-coherent protocol (such as AXI). In the flow 100, the converted request is based on a second communications protocol 154, wherein the translating is based on the checking. The second communications protocol can include a substantially different communications protocol from the first communications protocol. In embodiments, the second communications protocol can include a non-coherent protocol. The non-coherent protocol can be based on data extraction from the amplitude and the phase of the received signal. In embodiments, the second communications protocol can include an AMBA™ AXI™ protocol. In a usage example, the request, based on a coherent protocol such as AMBA™ CHI™ protocol, can be translated to a non-coherent protocol such as AMBA™ AXI™ protocol. The flow 100 includes transmitting, by the CC, the converted request 160 to the target device. The transmitting can be accomplished using the mesh network. The target device can include a controller. In embodiments, the target device can be a memory controller. The memory controller can control local memory, shared memory, etc. In other embodiments, the target device can be an I/O controller. The I/O controller can control read requests and write requests to target devices that are beyond the SoC. The flow 100 includes adding a response from the target device to the response queue 170. The response queue can be based on a FIFO. More than one FIFO can be used. In a usage example, a response to a read request can be added to a read response FIFO, and a response to a write request can be added to a write FIFO. The responses can be enqueued. Discussed previously, responses can be matched by the CC to the request that resulted in the response. Embodiments can include matching, by the CC, the response that was enqueued. The matching can be based on the memory address that was accessed by the request. In embodiments, the matching can be accomplished by a content addressable memory (CAM).

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

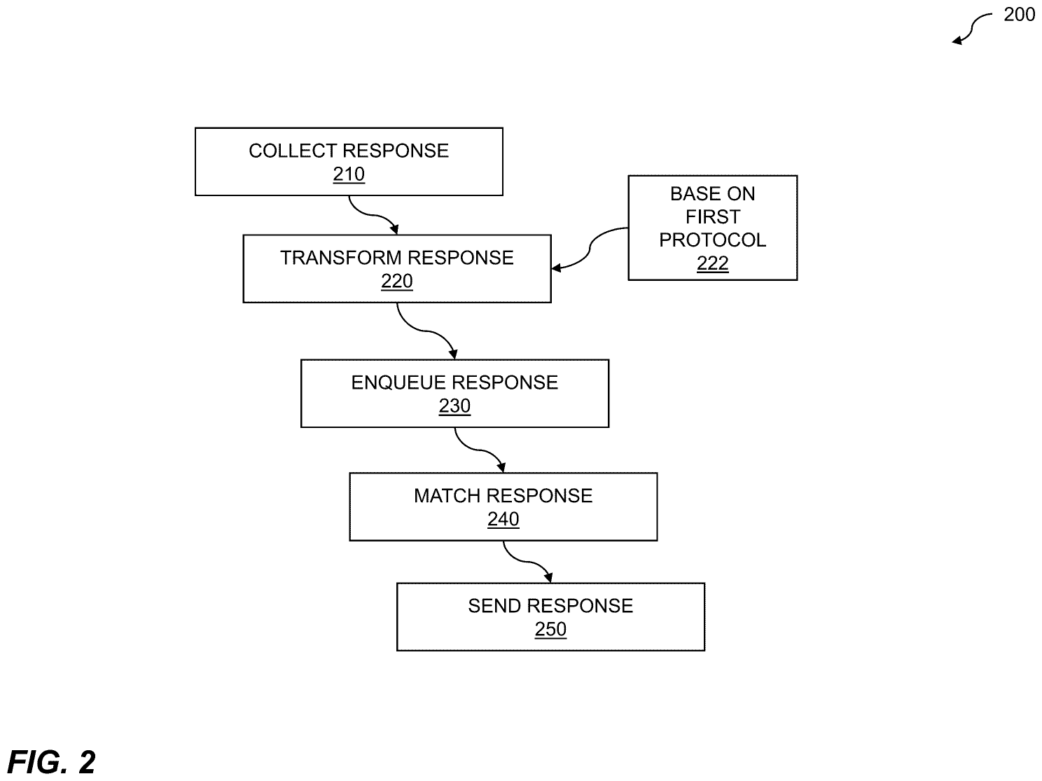

FIG. 2 is a flow diagram for sending a response. A response can result from a request sent by a processor within the one or more processors being transmitted to a target device. The target device can include a memory controller, an I/O controller, and so on. The request can include a request to read or load data, to write or store data, and so on. The request can include reading data from or writing data to a memory address, reading data from or writing data to an I/O interface, and the like. The sending the response can include sending the response from a target device back to the processor that sent the request that resulted in the response. The request and the response can be based on different communications protocols. A first communications protocol can be converted or translated to a second communications protocol. The second communications protocol can be converted or translated to the first communications protocol. The sending a response is enabled by communications protocol conversion over a mesh interconnect. A system-on-chip (SoC) is accessed. The SoC includes a mesh network and one or more coherency ordering agents (COAs), where the one or more COAs coordinate coherency for one or more processors coupled to the mesh network. The one or more COAs are coupled to one or more communication converters (CCs) by the mesh network. A processor within the one or more processors sends a request to a target device. The request is based on a first communications protocol, the request includes a memory address, and the request is sent, by a COA within the one or more COAs, to a CC within the one or more CCs. The request is stored by a request queue, where the request queue is within the CC. The request is checked based on one or more additional requests. The request is translated by CC, where the translating results in a converted request. The converted request is based on a second communications protocol, and the translating is based on the checking. The converted request is transmitted by the CC to the target device.

The flow 200 includes collecting, by a communication converter (CC), from the target device, a response 210, wherein the response is responsive to the converted request. Discussed previously, a request from a processor is stored within the request queue within a CC. The target device receives the request and generates a response to the request. The response can include contents of a memory location, data from an I/O operation, and so on. The flow 200 includes transforming the response 220, wherein the transforming results in a converted response. In the flow 200, the converted response is based on the first communications protocol 222. Recall that a request from a processor can be based on a first communications protocol.

The request is translated by a CC resulting in a translated request, where the translated request can be based on a second communications protocol. The target device receives the translated request and responds to the request. The response can be based on the second communications protocol. The response based on the second communications protocol can be translated to the first communications protocol.

The flow 200 further includes enqueuing the response 230. The response can be enqueued in a buffer, such as a first-in first-out buffer (FIFO). More than one FIFO can be used to enqueue one or more responses. In a usage example, the FIFO in which the response is enqueued can include a read FIFO for responses to a read request, or a write FIFO for responses to a write request. The flow includes matching, by the CC, the response 240 that was enqueued, wherein the matching is based on the memory address. Recall that more than one request can be sent to a target device. In the event of multiple requests, the requests, and in particular write requests, can be sent to the target device based on an order. The order can be based on when the request was received, a coherency protocol or technique, and so on. As a result, the enqueued response can be matched to a particular request so that the response is sent back to that particular request. In embodiments, the matching can be accomplished by a content addressable memory (CAM). The flow 200 further includes sending the response 250 to the processor, wherein the sending is based on the matching. Having determined which response was collected as a result of a request from a processor, the response is sent back to the requesting processor. The response can be sent to the requesting processor via the CC.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

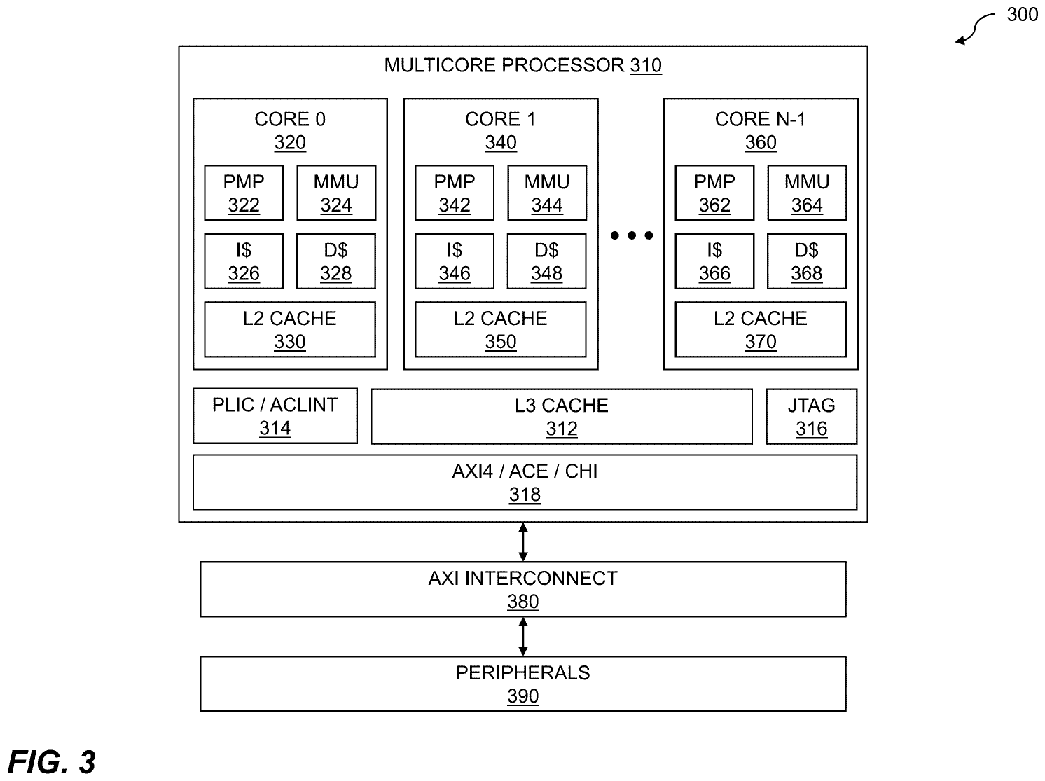

FIG. 3 is a block diagram for a multicore processor. The multicore processor, such as a RISC-V™ processor, ARM processor, or other suitable processor type, can include a variety of elements. The elements can include processor cores including multiprocessor cores, one or more caches, shared memory, memory protection and management units, local storage, and so on. In embodiments, the processor core translates requests to a target device from a first communications protocol to a second communications protocol. The elements of the multicore processor can further include one or more of a private cache; a test interface such as a joint test action group (JTAG) test interface; one or more interfaces to a network such as a network-on-chip, shared memory; and peripherals; and the like. The multicore processor enables communications protocol conversion over a mesh interconnect. A system-on-chip (SoC) is accessed. The SoC includes a mesh network and one or more coherency ordering agents (COAs), where the one or more COAs coordinate coherency for one or more processors coupled to the mesh network. The one or more COAs are coupled to one or more communication converters (CCs) by the mesh network. A processor within the one or more processors sends a request to a target device. The request is based on a first communications protocol, the request includes a memory address, and the request is sent, by a COA within the one or more COAs, to a CC within the one or more CCs. The request is stored by a request queue, where the request queue is within the CC. An older pending write request to the memory address is checked for. The request is translated by CC, where the translating results in a converted request. The converted request is based on a second communications protocol, and the translating is based on the checking. The converted request is transmitted by the CC to the target device.

In the block diagram 300, the multicore processor 310 can comprise two or more processors, where the two or more processors can include homogeneous processors, heterogeneous processors, etc. In the block diagram, the multicore processor can include N processor cores such as core 0 320, core 1 340, core N-1 360, and so on. Each processor can comprise one or more elements. In embodiments, each core, including cores 0 through core N-1 can include a physical memory protection (PMP) element, such as PMP 322 for core 0; PMP 342 for core 1, and PMP 362 for core N-1. In a processor architecture such as the RISC-V™ architecture, a PMP can enable processor firmware to specify one or more regions of physical memory, such as cache memory of the shared memory, and to control permissions to access the regions of physical memory. The cores can include a memory management unit (MMU) such as MMU 324 for core 0, MMU 344 for core 1, and MMU 364 for core N-1. The memory management units can translate virtual addresses used by software running on the cores to physical memory addresses within caches, the shared memory system, etc.

The processor cores associated with the multicore processor 310 can include caches such as instruction caches and data caches. The caches, which can comprise level 1 (L1) caches, can include an amount of storage such as 16 KB, 32 KB, and so on. The caches can include an instruction cache I$ 326 and a data cache D$ 328 associated with core 0; an instruction cache I$ 346 and a data cache D$ 348 associated with core 1; and an instruction cache I$ 366 and a data cache D$ 368 associated with core N-1. In addition to the level 1 instruction and data caches, each core can include a level 2 (L2) cache. The level 2 caches can include L2 cache 330 associated with core 0; L2 cache 350 associated with core 1; and L2 cache 370 associated with core N-1. The cores associated with the multicore processor 310 can include further components or elements. The further elements can include a level 3 (L3) cache 312. The level 3 cache, which can be larger than the level 1 instruction and data caches and the level 2 caches associated with each core, can be shared among all of the cores. The further elements can be shared among the cores. In embodiments, the further elements can include a platform level interrupt controller (PLIC) 314. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 316. The JTAG can provide a boundary within the cores of the multicore processor. The JTAG can enable fault information to a high precision. The high-precision fault information can be critical to rapid fault detection and repair.

The multicore processor 310 can include one or more interface elements 318. The interface elements can support standard processor interfaces such as an Advanced eXtensible Interface (AXI™) such as AXI4™, an ARM™ Advanced eXtensible Interface (AXI™) Coherence Extensions (ACE™) interface, an Advanced Microcontroller Bus Architecture (AMBA™) Coherence Hub Interface (CHI™), etc. In the block diagram 300, the interface elements can be coupled to the interconnect. The interconnect can include a bus, a network, and so on. The interconnect can include an AXI™ interconnect 380. In embodiments, the network can include network-on-chip functionality. The AXI™ interconnect can be used to connect memory-mapped “master” or boss devices to one or more “slave” or worker devices. In the block diagram 300, the AXI interconnect can provide connectivity between the multicore processor 310 and one or more peripherals 390. The one or more peripherals can include storage devices, networking devices, and so on. The peripherals can enable communication using the AXI™ interconnect by supporting standards such as AMBA™ version 4, among other standards.

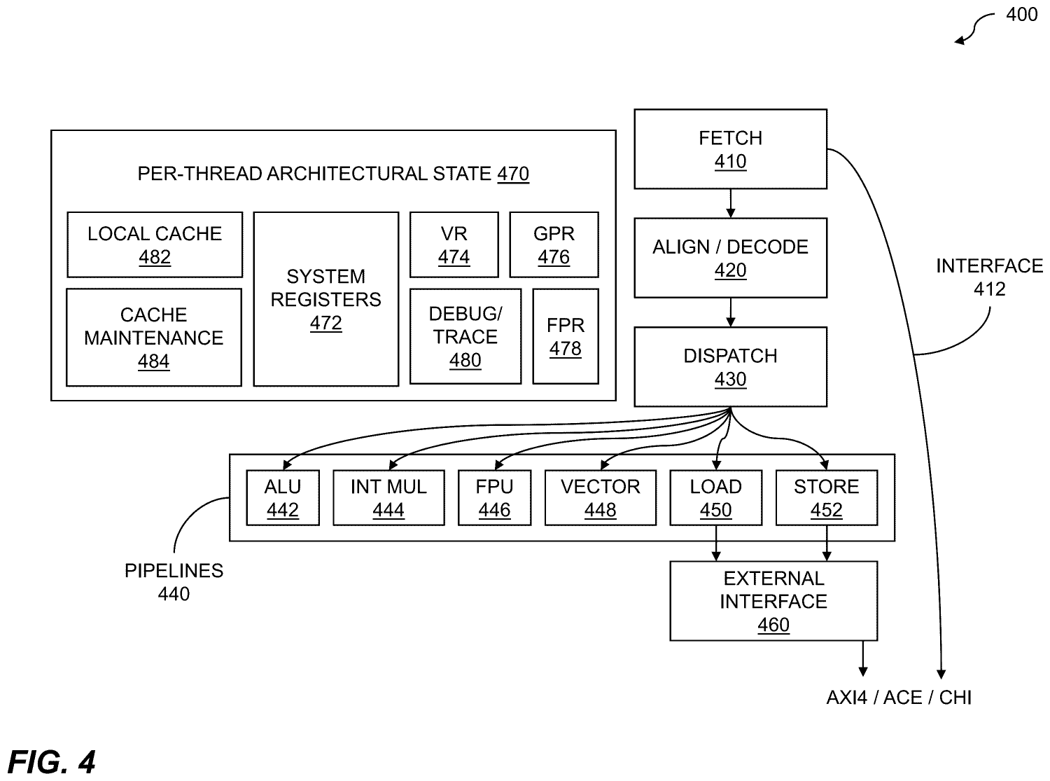

FIG. 4 is a block diagram 400 for a pipeline. The use of one or more pipelines associated with a processor architecture can greatly enhance processing throughput. The processor architecture can be associated with one or more processor cores. The processing throughput can be increased because multiple operations can be executed in parallel. In embodiments, a processor core is accessed, where the processor core supports sharing data. The sharing data is enabled by communications protocol conversion over a mesh interconnect. A system-on-chip (SoC) is accessed, where the SoC includes a mesh network and one or more coherency ordering agents (COAs). The one or more COAs coordinate coherency for one or more processors coupled to the mesh network, and the one or more COAs are coupled to one or more communication converters (CCs) by the mesh network. A processor within the one or more processors sends a request to a target device, where the request is based on a first communications protocol. The request includes a memory address, and the request is sent, by a COA within the one or more COAs, to a CC within the one or more CCs. A request queue stores the request, where the request queue is within the CC. An older pending write request to the memory address is checked for. The request is translated by the CC, where the translating results in a converted request. The converted request is based on a second communications protocol, and the translating is based on the checking. The converted request is transmitted by the CC to the target device.

The blocks within the block diagram can be configurable in order to provide varying processing levels. The varying processing levels can be based on processing speed, bit lengths, numbers of micro-operations, and so on. The block diagram 400 can include a fetch block 410. The fetch block 410 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 412. The interface can include a standard interface such as one or more industry standard interfaces. The interfaces can include an Advanced eXtensible Interface (AXI™), an ARM™ Advanced eXtensible Interface (AXI™) Coherence Extensions (ACE™) interface, an Advanced Microcontroller Bus Architecture (AMBA™) Coherence Hub Interface (CHI™), etc.

The block diagram 400 includes an align and decode block 420. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 400 can include a dispatch block 430. The dispatch block can receive decoded instruction packets from the align and decode block. The decoded instruction packets can be used to control a pipeline 440, where the pipeline can include an in-order pipeline, an out-of-order (OoO) pipeline, etc. In embodiments, the processor core executes one or more instructions out of order. A pipeline can be associated with the one or more execution units. The pipelines associated with the execution units can include processor cores, arithmetic logic unit (ALU) pipelines 442, integer multiplier pipelines 444, floating-point unit (FPU) pipelines 446, vector unit (VU) pipelines 448, and so on. The dispatch unit can further dispatch instructions to pipelines that can include load pipelines 450, and store pipelines 452. The load pipelines and the store pipelines can access storage such as the common memory using an external interface 460. The external interface can be based on one or more interface standards such as the Advanced eXtensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In embodiments, the plurality of processors can be configured to support multi-threading. The system block diagram can include a per-thread architectural state block 470. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 472. The system registers can be associated with individual processors, a system comprising multiple processors, and so on. The system registers can include exception and interrupt components, counters, etc. The per-thread architectural state can include further registers such as vector registers (VRs) 474. The vector registers can be grouped in a vector register file and can be used for vector operations. In embodiments, the width of the vector register file is 512 bits. Additional registers such as general-purpose registers (GPRs) 476 and floating-point registers (FPRs) 478 can be included. These registers can be used for general purpose (e.g., integer) operations, and floating-point operations, respectively. The per-thread architectural state can include a debug and trace block 480. The debug and trace block can enable debug and trace operations to support code development, troubleshooting, and so on. In embodiments, an external debugger can communicate with a processor through a debugging interface such as a joint test action group (JTAG) interface. The per-thread architectural state can include a local cache state 482. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 484. The cache maintenance state can include maintenance needed, maintenance pending, maintenance complete, etc.

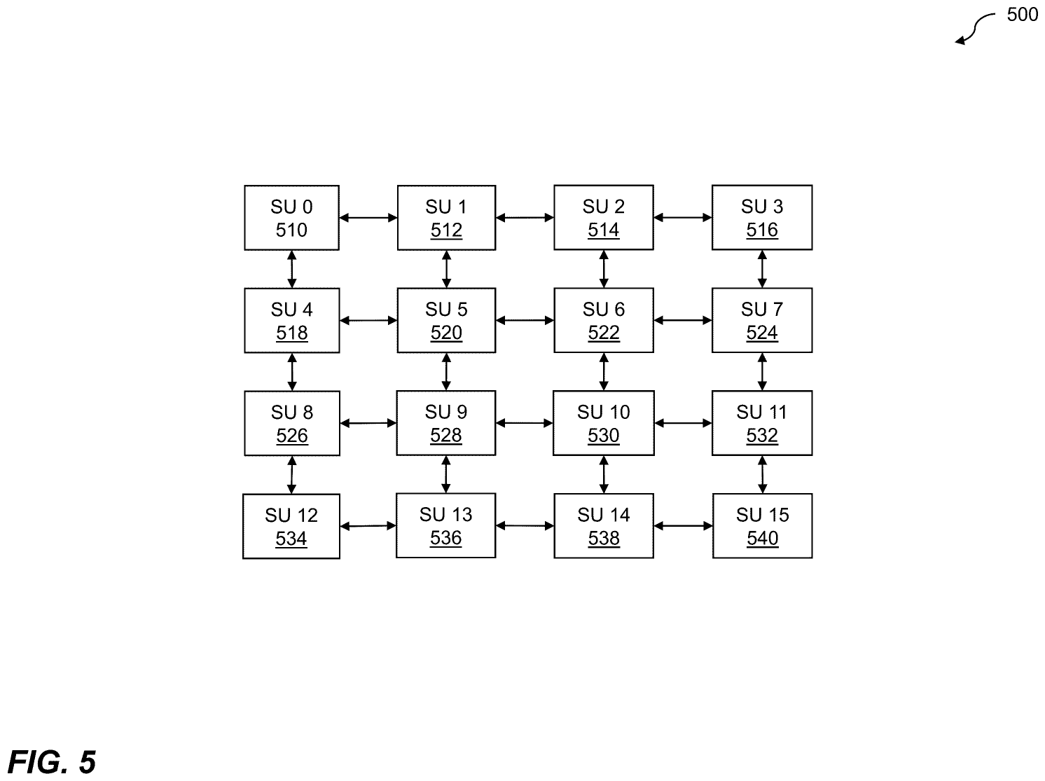

FIG. 5 is a block diagram of a mesh network. The mesh network can comprise a plurality of switching units (SUs). Discussed previously and throughout, a processor can send a request to a target device. The request can include a memory access request such as a memory load (read) request or a memory store (write) request. The request can be based on a first communications protocol, and the request includes a memory address. Memory access requests must be coherent in order for the memory access request to be valid. In a usage example, a data request by a processor within the SoC to load data can require inspection of other coherent caches within the SoC to determine if a dirty bit associated with a memory address is set. If so, the data must be returned to the processor via that cache instead of the memory subsystem. The coherency can be based on a protocol such as MESI, MOESI, AMBA™, ACE™, AMBA™, CHI™, and so on. The coherency protocol can include snooping between caches or memory elements within the SoC to maintain coherency in the system and ensure that no data is lost. In another usage example, the data that is loaded from the requested load address can require that the data must be the latest data rather than older, stale data. Further complicating data access, the communications protocol used for the request can be different from the communications protocol used by a target device. Communications with the mesh network of switching units can be enabled by communications protocol conversion over a mesh interconnect.

A system-on-chip (SoC) is accessed, where the SoC includes a mesh network and one or more coherency ordering agents (COAs). The one or more COAs coordinate coherency for one or more processors coupled to the mesh network, and the one or more COAs are coupled to one or more communication converters (CCs) by the mesh network. A processor within the one or more processors sends a request to a target device, where the request is based on a first communications protocol. The request includes a memory address, and the request is sent, by a COA within the one or more COAs, to a CC within the one or more CCs. A request queue stores the request, where the request queue is within the CC. An older pending write request to the memory address is checked for. The request is translated by the CC, where the translating results in a converted request. The converted request is based on a second communications protocol, and the translating is based on the checking. The converted request is transmitted by the CC to the target device.

Switching units can be configured in an M×N mesh topology. The FIG. 500 shows an example 4×4 mesh. The switching units within the mesh can include switching units SU 0 510, SU 1 512, SU 2 514, SU 3 516, SU 4 518, SU 5 520, SU 6 522, SU 7 524, SU 8 526, SU 9 528, SU 10 530, SU 11 532, SU 12 534, SU 13 536, SU 14 538, and SU 15 540. In embodiments, a node at each point of the M×N mesh topology can include a switching unit (SU). A switching unit, which can also be referred to as a mesh switch unit, can include one or more of a memory controller interface (MCI), an input/output (I/O) mesh interface (IMI), and so on. In embodiments, the SoC can include one or more coherency ordering agents (COAs). The one or more COAs coordinate coherency for one or more processors coupled to the mesh network. The coherency can be associated with requests such as memory access requests. The one or more COAs can be coupled to one or more communication converters (CCs) by the mesh network. The CCs can convert requests such as memory access requests between devices. Data can be sent across the mesh from a first node within the mesh to a second node within the mesh. Each switching unit can include a plurality of ports. The ports can include local ports, directional ports, and the like. The ports can be used for communication with other switching units within the mesh. Each switching unit can be in communication with nearest-neighbor SUs within the matrix. The nearest neighbor SUs within the mesh topology can be in one or more cardinal directions. The cardinal directions can include north, south, east, and west directions. Communication with a nearest neighbor SU can be based on a cardinal direction priority. In embodiments, the cardinal direction priority can be east/west, then north/south. Noted above, the communication with nearest-neighbor SUs can be accomplished using a network-on-chip (NOC). The network-on-chip can be based on techniques including router-based packet switching.

Nodes within the M×N mesh can communicate using a network within a system-on-chip (SoC). Discussed previously, the network can include a mesh network. The mesh network can implement a network-on-chip (NOC) within the SoC. The network can include a packet network. The nodes within the mesh network can send requests to a target device such as a storage device. The storage device can include a scratchpad memory, a cache memory such as a local cache or shared cache, a shared memory, and so on. In order to maintain data coherency, and thereby to avoid memory race conditions, memory accesses are coordinated by the one or more coherency ordering agents (COAs) within the SOC. The COAs can order memory access requests such as load requests and store requests. The COAs are coupled to one or more communication converters (CCs). The COAs send requests to CCs for conversion. The CCs translate a request based on one communications protocol to a second communications protocol. Embodiments can include collecting, by the CC, from the target device, a response, where the response is responsive to the converted request. In a usage example, the response can include requested data that is required for processing. Further embodiments can include transforming the response. The transforming can result in a converted response, where the converted response is based on the first communications protocol.

Further embodiments can include enqueueing the response collected by the CC. The enqueuing can be used to buffer responses from a target device to the requesting device. Embodiments further include matching, by the CC, the response that was enqueued, where the matching is based on the memory address. Since the memory address can be the target of one or more access requests, the matching can determine which tasks, processes, etc., requested access to the memory address. A variety of techniques can be used for accomplishing the matching. In embodiments, the matching can be accomplished by a content addressable memory (CAM). The matching can determine which processor within the mesh network sent the request. Further embodiments can include sending the response to the processor, wherein the sending is based on the matching.

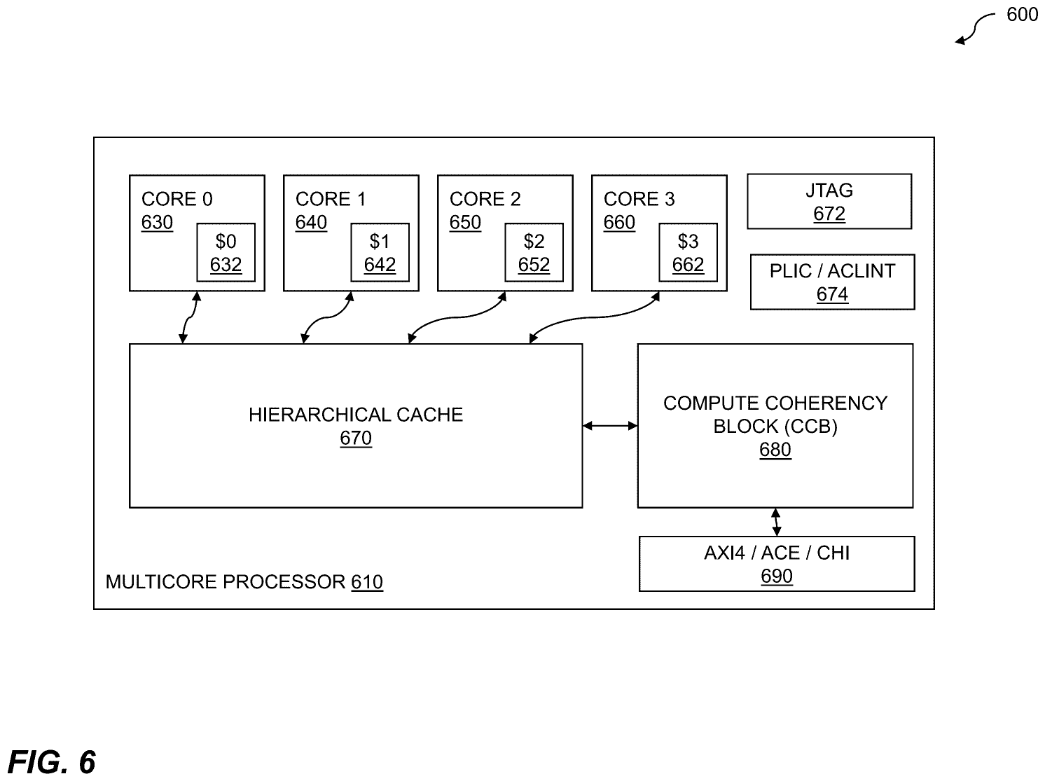

FIG. 6 is a block diagram of a compute coherency block (CCB). A compute coherency block can maintain coherency between processors that share a cache memory; between sets of processors that share cache memories and a shared cache, among processor/cache sets, a shared system cache, and system memory; and so on. The CCB can maintain coherency mesh network nodes that use a first communications protocol and target devices that use a second communications protocol. That is, the compute coherency block can be used to maintain storage coherency throughout a system, from a cache associated with a processor core up through the system memory. The compute coherency is enabled by checking and controlling write operations from one or more processors into storage. The compute coherency is further enabled by checking and controlling the orders of read operations and write operations from the one or more processors into storage. The compute coherency is maintained across communications protocols. The checking and controlling request operations from processors to target devices are enabled by communications protocol conversion over mesh interconnects. A system-on-chip (SoC) is accessed, where the SoC includes a mesh network and one or more coherency ordering agents (COAs). The one or more COAs coordinate coherency for one or more processors coupled to the mesh network, and the one or more COAs are coupled to one or more communication converters (CCs) by the mesh network. A processor within the one or more processors sends a request to a target device, where the request is based on a first communications protocol. The request includes a memory address, and the request is sent, by a COA within the one or more COAs, to a CC within the one or more CCs. A request queue stores the request, where the request queue is within the CC. An older pending write request to the memory address is checked for. The request is translated by the CC, where the translating results in a converted request. The converted request is based on a second communications protocol, and the translating is based on the checking. The converted request is transmitted by the CC to the target device.

A plurality of processor cores is accessed, wherein each processor of the plurality of processor cores includes a shared local cache, and wherein the shared local cache supports snoop operation. A snoop queue is coupled to the plurality of processor cores, wherein the snoop queue is shared among the plurality of processor cores. Two or more snoop operations are received for the shared local cache, wherein the two or more snoop operations point to a common cache-line physical address within the shared local cache, and wherein the two or more snoop operations are enqueued in the snoop queue. A snoop response is generated to a first snoop operation of the two or more snoop operations. A cache eviction operation is prevented from completing, based on the snoop response being completed with a positive cache-line physical address comparison, wherein the cache-line physical address comparison comprises a partial cache-line physical address comparison.

The block diagram 600 shows a multicore processor 610. The multicore processor includes compute coherency block (CCB) logic 680. The compute coherency block logic controls coherency among caches coupled to cores, a hierarchical cache, system memory, and so on. Multicore processor 610 includes core 0 630, core 1 640, core 2 650, and core 3 660. While four cores are shown in block diagram 600, in practice, there can be more or fewer cores. As an example, disclosed embodiments can include 16, 32, or 64 cores. Each core comprises an onboard local cache, which is referred to as a level 1 (L1) cache. Core 0 630 includes local cache 632, core 1 640 includes local cache 642, core 2 650 includes local cache 652, and core 3 660 includes local cache 662.

The multicore processor 610 can further include a hierarchical cache 670. The hierarchical cache 670 can be a level 2 (L2) cache that is shared among multiple cores within the multicore processor 610. In one or more embodiments, the hierarchical cache 670 is a last level cache (LLC). The multicore processor 610 can further include a joint test action group (JTAG) element 672. The JTAG element 672 can be used to support diagnostics and debugging of programs and/or applications executing on the multicore processor 610. The diagnostics and debugging are enabled by providing access to the processor's internal registers, memory, and other resources. In embodiments, the JTAG element 672 enables functionality for step-by-step execution, setting breakpoints, examining the processor's state during program execution, and/or other relevant functions. The multicore processor 610 can further include a platform level interrupt controller (PLIC), and/or advanced core local interrupter (ACLINT) element 674. The PLIC/ACLINT supports features including, but not limited to, interrupt processing and timer functionalities.

Multicore processor 610 further includes compute coherency block (CCB) logic 680. In one or more embodiments, the compute coherency block (CCB) logic 680 is responsible for maintaining coherency between one or more caches such as local caches associated with the processor cores, the hierarchical cache, a shared memory system, and so on. In embodiments, the CCB logic 680 interfaces to the hierarchical cache 670, and one or more interface elements (discussed below). The CCB logic interfaces to the system memory through the interface elements. The compute coherency block logic can perform one or more cache maintenance operations. In embodiments, the CMO can include a cache block operation (CBO) CLEAN instruction. The CCB logic can perform one or more CMO operations in order to resolve data inconsistencies due to “dirty” data in one or more caches. The dirty data can result from changes to the local copies of shared memory contents in the local caches, copies of shared memory contents in the hierarchical cache, etc. The changes to the local copies of data or the hierarchical cache copies of the data can result from processing operations performed by the processor cores as the cores execute code. Similarly, data in the shared memory can be different from the data in a local cache due to an operation such as a write operation. The multicore processor 610 can further include one or more interface elements 690, which can include standard processor interfaces such as an Advanced eXtensible Interface (AXI™) which can include AXI4™, an ARM™ Advanced eXtensible Interface (AXI™) Coherence Extensions (ACE™) interface, an Advanced Microcontroller Bus Architecture (AMBA™) Coherence Hub Interface (CHI™), as previously described.

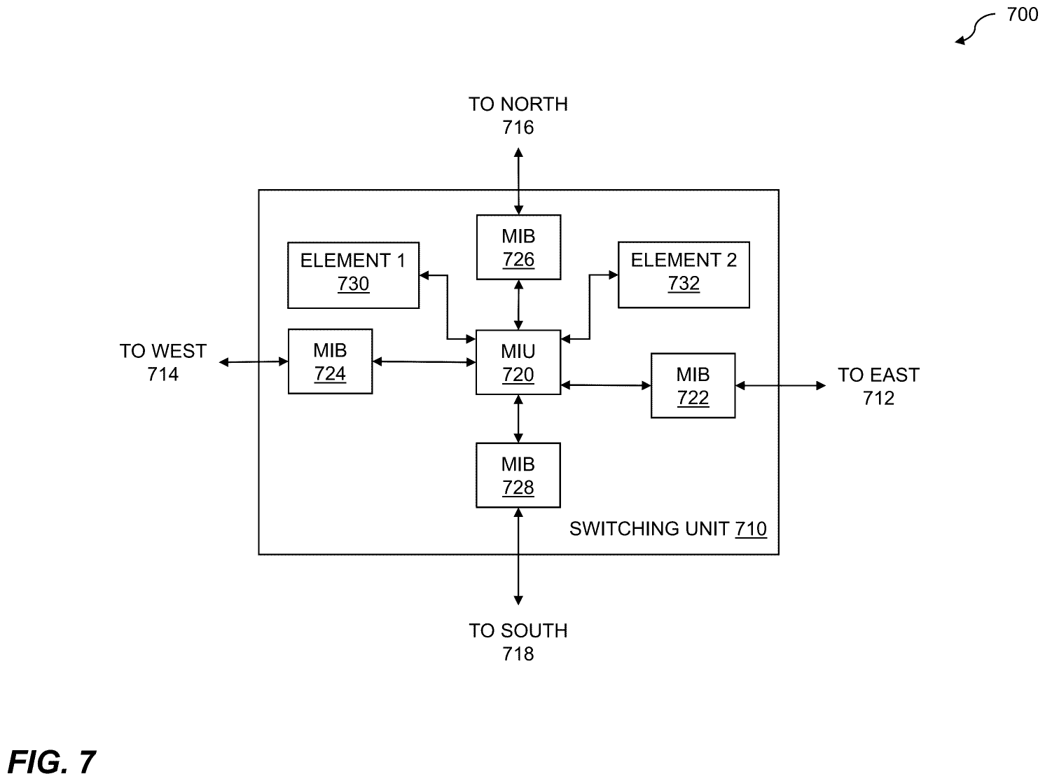

FIG. 7 is a block diagram of a switching unit (SU). Discussed previously and throughout, a plurality of switching units can be configured in an M×N topology such as an M×N mesh network, or topology. The switching units can include one or more of a memory controller interface, an I/O mesh interface, and so on. A SU or tile can further include elements for managing communication across the M×N topology. More than one communications protocol can be used for communicating between and among SUs. The various elements of a switching unit support communications protocol conversion over a mesh interconnect. The mesh network can be included in a system-on-chip (SoC). The SoC can further include one or more coherency ordering agents (COAs). The COAs can coordinate coherency for one or more processors coupled to the mesh network. Further, the one or more COAs can be coupled to one or more communication converters (CCs) by the mesh network. The network can include a mesh topology that comprises M×N elements. The M×N elements, which can be referred to generically as tiles or nodes associated with the mesh topology, can include various elements. The included elements can be based on a variety of node configurations that can perform a variety of operations. The nodes have been described as switching units (SUs), where the switching units can communicate with their nearest neighbor SUs that are located in a cardinal direction from each SU. A given SU can be configured to perform one or more operations. Each SU can include one or more elements. An SU can be configured as a coherent mesh unit (CMU), a memory controller interface (MCI), an input/output (I/O) mesh interface (IMI), and so on. A generic block diagram of a switching unit is shown 700. The SU can be configured to enable the sharing of data. In embodiments, the SU is configured to enable communications protocol conversion over a mesh interconnect. The communications protocol conversion enables the sharing of data. The switching unit 710 can communicate with nearest neighbor SUs that are located in cardinal directions from the SU 710. A nearest neighbor SU can include a node configured substantially similarly to the SU or configured differently. The nearest neighbor communications can include cardinal directions to the east 712, to the west 714, to the north 716, and to the south 718. For some routing situations, the cardinal directions can be prioritized. In a usage example, the cardinal direction priority can be east/west, then north/south. The switching unit can be configured to communicate with nearest neighbors in a diagonal direction such as northeast, southeast, southwest, and northwest. The prioritization can include the diagonal directions.

The switching unit 710 can include a mesh interface unit (MIU) 720. In embodiments, the MIU can initiate sending, by a processor within the one or more processors, a request to a target device. The request can include an access request such as a memory access request. A memory access request can include a load (read) operation, a store (write) operation, a read-modify-write operation, and so on. The requesting processor and the target device can use different communications protocols. The MIU can generate a request by a primary device within a first node to be sent to a secondary or target device. The target device can include a node within the mesh network, an element or device external to the mesh network, and the like. The MIU can communicate with other MIUs associated with further switching units using one or more interfaces. The switching unit can include one or more mesh interface blocks (MIBs). The MIBs can enable communication between the SU 710 and other SUs within the mesh. The other SUs can be located in cardinal directions from the SU 710. The SU shown can include four MIBs such as MIB 722, MIB 724, MIB 726, and MIB 728. MIB 722 enables communication to the east, MIB 724 enables communication to the west, MIB 726 enables communication to the north, and MIB 728 enables communication to the south.

The switching unit 710 comprises a node within a plurality of nodes within a system-on-a-chip (SoC). The node can include one or more coherency ordering agents (COAs). The COAs can coordinate coherency for one or more processors coupled to the mesh network. The coherency can enable ordering of requests such as a memory access request, including load requests and store requests, to be ordered to avoid access hazards. The access hazards can include read-before-write hazards, write-after-read hazards, etc. The one or more COAs can be coupled to one or more communication converters (CCs) by the mesh network. The CCs can convert between and among communications protocols.

The switching unit 710 can include one or more further elements such as element 1 730 and element 2 732. Element 1 and element 2 can include blocks that can perform various functions, blocks that can be configured to perform various operations, and so on. One or more configurations of element 1 and element 2 can be supported. In embodiments, element 1 730 of the node can include a cache coherency block (CCB). The cache coherency block can include processors such as processor cores, local cache memory, shared cache memory, intermediate memories, and so on. The CCB can include a “block” of storage, where the block can include one or more of shared local cache, shared intermediate cache, and so on. The CCB can maintain coherency among cores such as processor cores, tiles, switching units, etc. In embodiments, element 2 732 of the node can include a coherency ordering agent (COA). The COA can include a routing agent. The COA can be used to control coherency with other elements outside of the mesh network. The CCB and the COA can be included in one or more switching units within the mesh network of the SoC. In embodiments, the adjacent coherent node can include a CCB and a COA. The adjacent node CCB and COA can be used to maintain memory coherency within the adjacent coherent tile or SU. In embodiments, the adjacent SU can include one or more memory control interfaces (MCIs). The COA or routing agent can be used to route data between the requesting node that is sending a request to a target device. The request can include a memory access request such as a load request or a store request.

In other embodiments, element 1 730 of the node can include an input/output (I/O) controller interface (ICI). The ICI can manage and control requests from a processor within the SU to a target device. The request can include a memory address. The target device can include a memory device such as a local memory, a cache memory, a shared memory, etc. The request can include a read (load) request, a write (store) request, and so on. The request can include one of a plurality of requests. Embodiments can include checking for an older pending write request to the memory address. In order to maintain coherency, write requests and read requests must be ordered to avoid memory access hazards. Further embodiments can include adding the request to a response queue, wherein the adding is based on the checking. The response queue can order responses collected from the target device. In embodiments, element 2 732 of the node can include a communication converter (CC). The CC can convert a communications protocol to another communications protocol or from the other communications protocol to the original communications protocol. The communications protocols can include industry standard communications protocols, custom communications protocols, and so on. In embodiments, the first communications protocol can include a coherent protocol. A coherent protocol can enable local regeneration of amplitude and phase information for data extraction. In embodiments, the first communications protocol comprises an AMBA™ CHI™ protocol. The second communications protocol can include a substantially different communications protocol from the first communications protocol. In embodiments, the second communications protocol includes a non-coherent protocol. The non-coherent protocol can base data extraction from the amplitude and the phase of the received signal. In embodiments, the second communications protocol includes an AMBA™ AXI™ protocol. In other embodiments, the first communications protocol comprises an AMBA™ AXI™ protocol. In further embodiments, the second communications protocol includes an AMBA™ CHI™ protocol.

In other embodiments, element 1 730 of the node can include memory controller interface (MCI). The MCI can enable access to various storage elements such as memory elements accessible by the SoC. The memory elements can include a local scratchpad memory, a local memory such as a local cache memory, a shared cache memory, a shared memory system, and so on. In embodiments, the memory can include a content addressable memory (CAM). The CAM can be used to accomplish the checking for an older pending write request to a memory address. In other embodiments, the target device to which a request is sent by a processor can be a memory controller. In embodiments, element 2 732 of the node can include a communication converter (CC) as discussed above. The CC can convert between and among communications protocols. As discussed previously, the first communications protocol can include an AMBA™ CHI™ protocol, and the second communications protocol can include an AMBA™ AXI™ protocol. The CC can convert between protocols when the first and second communications protocols are reversed.

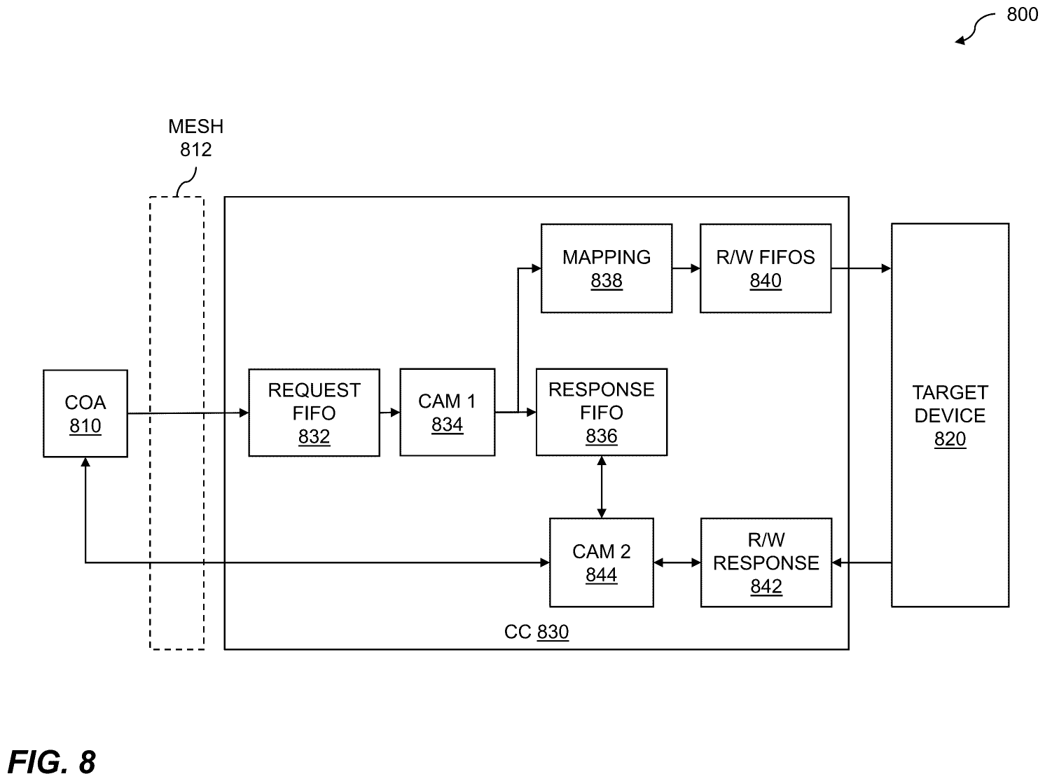

FIG. 8 is a first block diagram of a communication converter. The communication converter can convert between communications protocols such as a first communications protocol and a second communications protocol. The communication converter shown in block diagram 800 can convert from a first communication protocol such as AMBA™ CHI™ to a second communication protocol, such as AMBA™ AXI™ or AMBA™ ACE™. The first communications protocol can include a coherent communications protocol, and the second communications protocol can include a non-coherent communications protocol. Described previously and throughout, a processor with an SoC sends a request that includes a memory address to a target device. A coherency ordering agent (COA) sends the request to a communication converter (CC). The CC can be coupled between the COA and the target device to convert the request from a first communications protocol to a second communications protocol. The target device can send back a response. The response can be converted by the CC from the second communications protocol to the first communications protocol. The CC enables communications protocol conversion over mesh interconnects. A system-on-chip (SoC) is accessed. The SoC includes a mesh network and one or more coherency ordering agents (COAs), where the one or more COAs coordinate coherency for one or more processors coupled to the mesh network. The one or more COAs are coupled to one or more communication converters (CCs) by the mesh network. A processor within the one or more processors sends a request to a target device. The request is based on a first communications protocol, the request includes a memory address, and the request is sent, by a COA within the one or more COAs, to a CC within the one or more CCs. The request is stored by a request queue, where the request queue is within the CC. The request can be checked, based on one or more additional requests. The request is translated by CC, where the translating results in a converted request. The converted request is based on a second communications protocol, and the translating is based on the checking. The converted request is transmitted by the CC to the target device.

The block diagram 800 can include a coherency ordering agent (COA) 810. The system-on-chip (SoC) can include one or more COAs. In embodiments, the COA coordinates coherency for one or more processors coupled to a mesh network within a system-on-chip (SoC). Recall that a processor among the processors within the SoC can send a request to a target device. In embodiments, the request is sent by a COA to a communication converter (CC) 830 within one or more CCs. The COAs are coupled to the CCs by the mesh network 812. A CC can convert a first communications protocol to a second communications protocol. In embodiments, the first communications protocol can include a coherent protocol. In embodiments, the first communications protocol can include an AMBA™ CHI ™ protocol. The second communications protocol can be different from the first communications protocol. In embodiments, the second communications protocol can include a non-coherent protocol. In embodiments, the second communications protocol comprises an AMBA™ AXI™ protocol. In this case, the CC can be located on the same tile within the mesh as the target device, which can be a different tile from the tile on which the COA is located.

In the block diagram 800, a communication converter 830 can be coupled between the COA 810 and the target device 820. The coupling can include the mesh 812 as shown on block diagram 800. Discussed previously, the CC 830 can handle requests, track multiple requests such as write requests that access a common memory address, and so on. Embodiments can include storing the request, by a request queue, wherein the request queue is within the CC. In the block diagram 800, the request queue can include a request first-in first-out (FIFO) 832. The request FIFO can store the requests in the order in which they are received from a processor. The block diagram 800 can include a content addressable memory (CAM) such as CAM 1 834. The CAM can be used to determine whether the memory address associated with a request matches one or more memory addresses associated with one or more other requests. Embodiments can include checking for an older pending write request to the memory address. In order to maintain memory coherency, an older pending write request can be executed prior to a more recently received write request to the same memory address. A response to the checking can be received. If a negative response is received, then there is no address match with older write requests. If no older write requests are pending with the same address, then embodiments can include enqueuing the response. In the block diagram 800, a response can be loaded into a response FIFO 836.

The block diagram 800 can include a mapping element 838. When a request in a first communication protocols, such as an AMBA™ CHI™ protocol, is received, the AMBA™ CHI™ protocol request can be mapped to an AMBA™ AXI™ protocol request. The mapping can be accomplished by the mapping element. The mapping element can include logic for translating between protocols. Such logic can handle different data formats between communication protocols such as a difference between cacheable and non-cacheable data, differences between bufferable and non-bufferable data, different data channels, different data fields, packetizing or depacketizing data, and so on.

The mapped requests can be enqueued in a FIFO. The block diagram can include a read/write FIFO 840. The read FIFO can store read requests, and the write FIFO can store write requests. Requests from the read FIFO and the write FIFO can be submitted to the target device 820. Responses from the target device can be enqueued into response FIFOs. The block diagram 800 can include read/write response FIFOs 842. The read response FIFO can store read responses, and the write response FIFO can store write responses. The read responses and the write responses can be compared using a CAM such as CAM 2 844 against contents of the response FIFO 836. The request that has received a response can be dequeued. The dequeued response can be forwarded to the COA, to the mesh interconnect, and on to the requesting processor. In embodiments, the sending can be based on one or more link credits. The link credits can be used to control a number of requests that are sent, where one send operation can be allowed per link credit. The number of link credits can be based on pending responses. Requests can be stalled. Embodiments can include stalling the request, wherein the stalling is based on the one or more link credits. In embodiments, CAM 1 834 can show that a write response is pending. The write can include an address of a previously sent write request. Thus, the write request can be stalled until the previously sent write request receives a response.

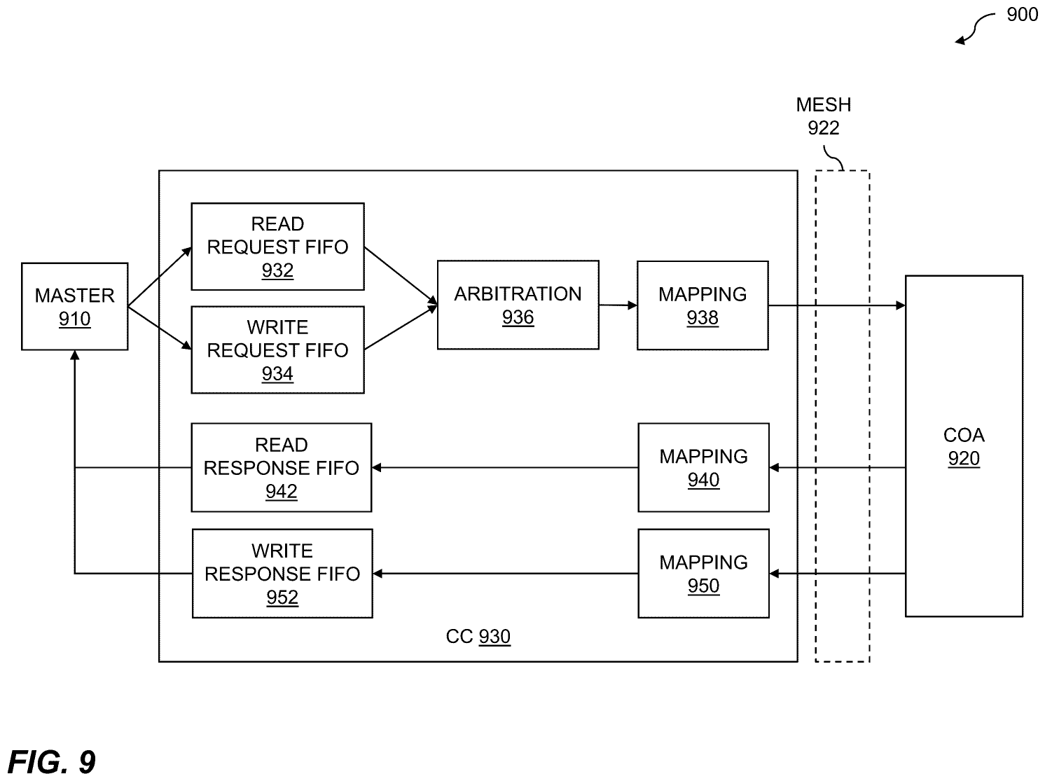

FIG. 9 is a second block diagram of a communication converter. The communication converter can convert between communications protocols such as a first communications protocol and a second communications protocol. The communication converter shown in the block diagram 900 can convert from a first communication protocol such as AMBA™ AXI™ or AMBA ACE™ to a second communication protocol, such as AMBA™ CHI™. The block diagram 900 can include a master device 910. The master device can initiate a request within the SoC. The master device can comprise a PCI-Express controller, an I/O controller, and so on. The source can be based on a non-coherent interconnect. The system-on-chip (SoC) can include one or more such master devices. In the block diagram 900, the master device can be coupled to a CC 930. The CC can convert the request from the first communications protocol to the second communications protocol. The CC can convert a first communications protocol to a second communications protocol. In embodiments, the first communications protocol can include a coherent protocol. In embodiments, the first communications protocol can comprise an AMBA™ AXI ™ protocol. In embodiments, the second communications protocol comprises an AMBA™ CHI™ protocol. In this case, the CC and the master device can be located on a first tile within the SoC. The target device can be a COA 920. The COA can be located on a second tile within the SoC. The first tile and the second tile can be coupled by the mesh network 922.

In the block diagram 900, a communication converter 930 can be coupled between the master device 910 and the target device 920. Discussed previously, the CC can handle requests, track multiple requests such as write requests that access a common memory address, and so on. Embodiments include storing the request, by a request queue, wherein the request queue is within the CC. In some first protocols, such as AMBA™ AXI™, read and write requests can be presented over separate channels. Thus, the CC can include more than one request queue. The request queues can comprise a first-in-first-out buffer (FIFO). In the block diagram 900, a read request FIFO 932 is shown to store one or more read requests from the master device. The block diagram 900 also shows a write request FIFO 934 to store one or more write requests from the master device. In some second protocols, such as AMBA™ CHI™, read and write requests can be presented on the same request channel. Thus, the CC includes arbitration 936. The arbitration can select between read requests and write requests within the read and write FIFOs. The arbitration can be based on an arbitration protocol. The arbitration protocol can comprise a round robin protocol.

The block diagram 900 can include a mapping element 938. When a request in a first communication protocols is received, such as an AMBA™ AXI™ protocol, the AMBA™ AXI™ protocol request can be mapped to an AMBA™ CHI™ protocol request. The mapping can be accomplished by the mapping element. The mapping element can include logic for translating between protocols. Such logic can handle different data formats between communication protocols such as a difference between cacheable and non-cacheable data, differences between bufferable and non-bufferable data, different data channels, different data fields, packetizing or depacketizing data, and so on. The mapped requests can be sent to the target device. In this case, the target device can be a COA. The target device can respond to the request that was mapped. In a protocol such as AMBA™ CHI™, read and write responses can be sent over separate channels. Thus, read responses can be mapped back to the first communications protocol by mapping element 940 while write responses can be mapped back to the first communications protocol by mapping element 950. The respective responses can be enqueued in a FIFO such as a read response FIFO 942 and a write response FIFO 952. The FIFOs can be used to return read and write responses, respectively, to the master device. In embodiments, the sending can be based on one or more link credits. The link credits can be used to control a number of requests that are sent, where one send operation can be allowed per link credit. The number of link credits can be based on pending responses. Requests can be stalled. Embodiments can include stalling the request, wherein the stalling is based on the one or more link credits.

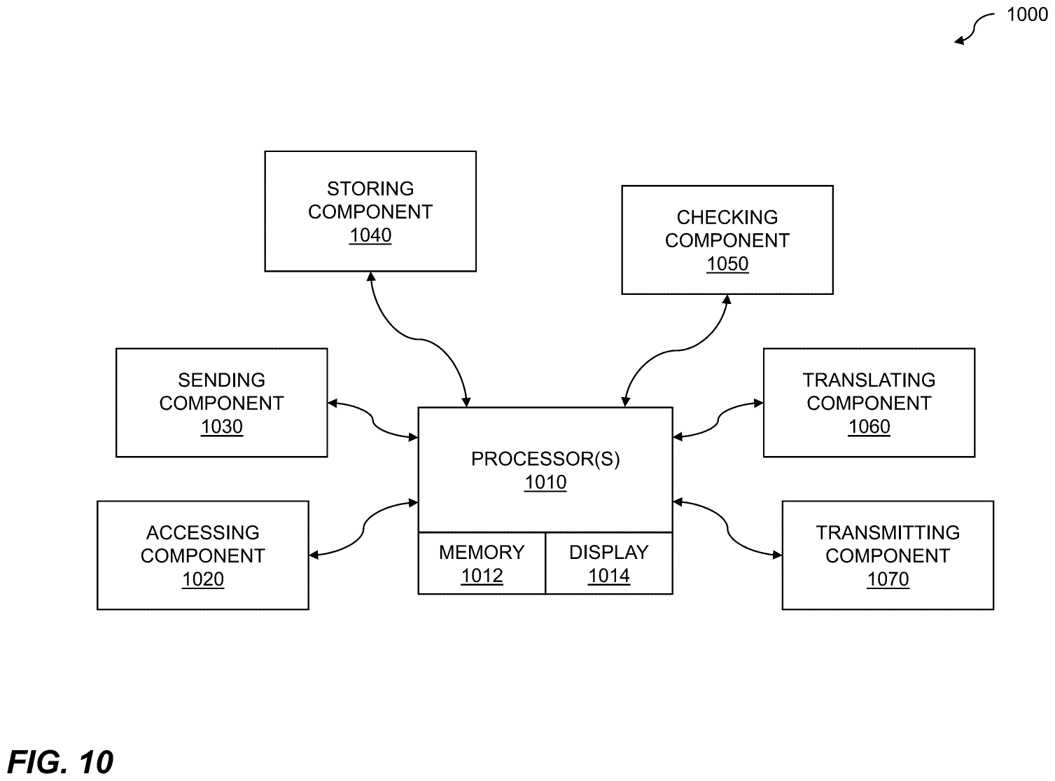

FIG. 10 is a system diagram for a communications protocol conversion over a mesh interconnect. The system can include one or more of processors, memories, cache memories, displays, and so on. The system 1000 can include one or more processors 1010. The processors can include standalone processors within integrated circuits or chips, processor cores in FPGAs or ASICs, and so on. The one or more processors 1010 are coupled to a memory 1012 which stores operations. The memory can include one or more of local memory, cache memory, system memory, etc. The system 1000 can further include a display 1014 coupled to the one or more processors 1010. The display 1014 can be used for displaying data, instructions, operations, micro-operations, and the like. The display can be used further for displaying processor requests, responses from target devices, and the like. A computer system comprising the one or more processors 1010 coupled to the memory 1012, when executing the instructions which are stored, are configured to: access a system-on-chip (SoC), wherein the SoC includes a mesh network and one or more coherency ordering agents (COAs), wherein the one or more COAs coordinate coherency for one or more processors coupled to the mesh network, and wherein the one or more COAs are coupled to one or more communication converters (CCs) by the mesh network; send, by a processor within the one or more processors, a request to a target device, wherein the request is based on a first communications protocol, wherein the request includes a memory address, and wherein the request is sent, by a COA within the one or more COAs, to a CC within the one or more CCs; store the request, by a request queue, wherein the request queue is within the CC; check the request, wherein the checking is based on one or more additional requests; translate, by the CC, the request, wherein the translating results in a converted request, wherein the converted request is based on a second communications protocol, and wherein the translating is based on the checking; and transmit, by the CC, the converted request to the target device.

The system 1000 can include an accessing component 1020. The accessing component 1020 can include functions and instructions accessing a system-on-chip (SoC). The SoC can include a variety of elements such as processing elements, storage elements, networking elements, and so on. The SoC includes a mesh network and one or more coherency ordering agents (COAs). The mesh network can interconnect two or more nodes. In embodiments, the node can include switching units (SUs). Coherency can ensure that access operations such as memory access operations occur in a proper order. Coherency can control load (read) operations and store (write) operations so that valid data is read from and written to memory. The one or more COAs can coordinate coherency for one or more processors coupled to the mesh network. The coordinated coherency can eliminate memory access hazards such as read-before-write hazards, write-after-read hazards, and so on. The one or more COAs are coupled to one or more communication converters (CCs) by the mesh network. The CCs can convert a request such as a memory access from a first communications protocol to a second communications protocol, and from the second communications protocol back to the first communications protocol. More than two communications protocols can be converted. The processors within the SoC can include processor cores. A processor core can include an ARM core, a MIPS core, and/or other suitable core type. In embodiments, the processor core can include a RISC-V architecture. The processor core can include a processor core within a plurality of processor cores. The RISC-V architecture can include extensions, where the extensions can enable execution of various arithmetic and logic operations. In embodiments, RISC-V architecture can include extensions that enable the communications protocol conversions.

The system 1000 can include a sending component 1030. The sending component 1030 can include functions and instructions for sending, by a processor within the one or more processors, a request to a target device. The target device can include a processor, an interface, a memory, and so on. In embodiments, the request can include a read request. The read (load) request can request access to contents of a memory address. In other embodiments, the request can include a write request. The write (store) request can request access to overwrite contents of a memory address. Discussed previously, the sending can be based on one or more link credits. The target device can include a controller. In embodiments, the target device can be a memory controller. A memory controller can control a variety of types of memory such as a local memory, a cache memory, a shared cache memory, a system memory, and the like. In other embodiments, the target device can be an I/O controller. The I/O controller can control inputs and outputs to a processor such as a processor within a COA. The request is based on a first communications protocol. The communications protocol can include a standard communications protocol such as an AMBA™ CHI™ protocol and an AMBA™/AXI™ protocol. The communications protocols can include one or more coherent protocols, one or more non-coherent protocols, etc. The request includes a memory address. The memory address can include a relative address, an absolute address, and the like. The memory address can reference a memory within the SoC or a memory beyond the SoC. The request is sent, by a COA within the one or more COAs, to a CC within the one or more CCs. The request can be sent from an element such as a first-in first-out element. The CC can convert the request from the first communications protocol to the second communications protocol.

The system 1000 can include a storing component 1040. The storing component 1040 can include functions and instructions for storing the request, by a request queue, wherein the request queue is within the CC. The request queue can store a list of requests sent to the target device. The requests can include memory access requests. The memory access requests can include read requests, write requests, read-modify-write requests, and so on. The request queue can be based on a first-in first-out (FIFO). The requests can be sent by any one of the one or more processors within the SoC. The requests in the request queue can be compared or checked against other requests such as previously received requests. The system 1000 can include a checking component 1050. The checking component 1050 can include functions and instructions for checking the request, wherein the checking is based on one or more additional requests. One or more older pending write requests to the memory address can change the contents of the memory address. Thus, the order in which the pending write requests are executed is critical to maintaining coherency. The ordering the pending write requests can prevent memory access hazards (e.g., making the data incoherent) such as a write-before-read hazard which can overwrite valid data; a read-before-write hazard which can result in obtaining stale data; etc.

The system 1000 can include a translating component 1060. The translating component 1060 can include functions and instructions for translating, by the CC, the request, wherein the translating results in a converted request, wherein the converted request is based on a second communications protocol, and wherein the translating is based on the checking. The translating can include translating the request from a first communications protocol to a second communications protocol. The first communications protocol and the second communications protocol can be based on a standard communications protocol, a communications protocol implemented for the SoC, and so on. In embodiments, the first communications protocol can include a coherent protocol. The coherent protocol can locally recreate frequency and phase of data to enable and enhance data extraction. In embodiments, the first communications protocol can include an AMBA™ CHI™ protocol. Other standard communications protocols can be supported. In embodiments, the second communications protocol can include a non-coherent protocol. A non-coherent protocol can include extracting data from a request as received without locally enhancing the received request. In embodiments, the second communications protocol can include an AMBA™/AXI™ protocol.

The system 1000 can include a transmitting component 1070. The transmitting component 1070 can include functions and instructions for transmitting, by the CC, the converted request to the target device. The target device can include a device within the SoC, coupled to the SoC, accessible to the SoC, and so on. In embodiments, the target device can be a memory controller. The memory controller can include a memory such as a local memory, a cache memory, a shared cache memory, a shared system memory, and so on. In other embodiments, the target device can be an I/O controller. The I/O controller can control various I/O devices. The I/O devices can enable communication between and among processors such as processors associated with switching units within the mesh network.

The system 1000 can include a computer program product embodied in a non-transitory computer readable medium for sharing data, the computer program product comprising code which causes one or more processors to generate semiconductor logic for: accessing a system-on-chip (SoC), wherein the SoC includes a mesh network and one or more coherency ordering agents (COAs), wherein the one or more COAs coordinate coherency for one or more processors coupled to the mesh network, and wherein the one or more COAs are coupled to one or more communication converters (CCs) by the mesh network; sending, by a processor within the one or more processors, a request to a target device, wherein the request is based on a first communications protocol, wherein the request includes a memory address, and wherein the request is sent, by a COA within the one or more COAs, to a CC within the one or more CCs; storing the request, by a request queue, wherein the request queue is within the CC; checking the request, wherein the checking is based on one or more additional requests; translating, by the CC, the request, wherein the translating results in a converted request, wherein the converted request is based on a second communications protocol, and wherein the translating is based on the checking; and transmitting, by the CC, the converted request to the target device.

The system 1000 can include a computer system for sharing data comprising: a memory which stores instructions; one or more processors coupled to the memory, wherein the one or more processors, when executing the instructions which are stored, are configured to: access a system-on-chip (SoC), wherein the SoC includes a mesh network and one or more coherency ordering agents (COAs), wherein the one or more COAs coordinate coherency for one or more processors coupled to the mesh network, and wherein the one or more COAs are coupled to one or more communication converters (CCs) by the mesh network; send, by a processor within the one or more processors, a request to a target device, wherein the request is based on a first communications protocol, wherein the request includes a memory address, and wherein the request is sent, by a COA within the one or more COAs, to a CC within the one or more CCs; store the request, by a request queue, wherein the request queue is within the CC; check for an older pending write request to the memory address; translate, by the CC, the request, wherein the translating results in a converted request, wherein the converted request is based on a second communications protocol, and wherein the translating is based on the checking; and transmit, by the CC, the converted request to the target device.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for sharing data comprising:
accessing a system-on-chip (SoC), wherein the SoC includes a mesh network and one or more coherency ordering agents (COAs), wherein the one or more COAs coordinate coherency for one or more processors coupled to the mesh network, and wherein the one or more COAs are coupled to one or more communication converters (CCs) by the mesh network;
sending, by a processor within the one or more processors, a request to a target device, wherein the request is based on a first communications protocol, wherein the request includes a memory address, and wherein the request is sent, by a COA within the one or more COAs, to a CC within the one or more CCs;
storing the request, by a request queue, wherein the request queue is within the CC;
checking the request, wherein the checking is based on one or more additional requests;
translating, by the CC, the request, wherein the translating results in a converted request, wherein the converted request is based on a second communications protocol, and wherein the translating is based on the checking; and
transmitting, by the CC, the converted request to the target device.

2. The method of claim 1 wherein the checking includes searching for an older pending write request to the memory address.

3. The method of claim 2 further comprising adding the request to a response queue, wherein the adding is based on the searching.

4. The method of claim 3 further comprising collecting, by the CC, from the target device, a response, wherein the response is responsive to the converted request.

5. The method of claim 4 further comprising transforming the response, wherein the transforming results in a converted response, wherein the converted response is based on the first communications protocol.

6. The method of claim 5 further comprising enqueuing the response.

7. The method of claim 6 further comprising matching, by the CC, the response that was enqueued, wherein the matching is based on the memory address.

8. The method of claim 7 wherein the matching is accomplished by a content addressable memory (CAM).

9. The method of claim 8 further comprising sending the response to the processor, wherein the sending is based on the matching.

10. The method of claim 1 wherein the sending is based on one or more link credits.

11. The method of claim 10 further comprising stalling the request, wherein the stalling is based on the one or more link credits.

12. The method of claim 1 wherein the first communications protocol comprises a coherent protocol.

13. The method of claim 12 wherein the first communications protocol comprises an AMBA™ CHI™ protocol.

14. The method of claim 12 wherein the second communications protocol comprises a non-coherent protocol.

15. The method of claim 14 wherein the second communications protocol comprises an AMBA™/AXI™ protocol.

16. The method of claim 1 wherein the checking is accomplished with a content addressable memory (CAM).

17. The method of claim 1 wherein the target device is a memory controller.

18. The method of claim 1 wherein the target device is an I/O controller.

19. The method of claim 1 wherein the first communications protocol comprises an AMBA™/AXI™ protocol.

20. The method of claim 19 wherein the second communications protocol comprises an AMBA™ CHI™ protocol.

21. The method of claim 1 wherein the checking includes arbitrating between the request and the one or more additional requests.

22. A computer program product embodied in a non-transitory computer readable medium for sharing data, the computer program product comprising code which causes one or more processors to generate semiconductor logic for:
accessing a system-on-chip (SoC), wherein the SoC includes a mesh network and one or more coherency ordering agents (COAs), wherein the one or more COAs coordinate coherency for one or more processors coupled to the mesh network, and wherein the one or more COAs are coupled to one or more communication converters (CCs) by the mesh network;
sending, by a processor within the one or more processors, a request to a target device, wherein the request is based on a first communications protocol, wherein the request includes a memory address, and wherein the request is sent, by a COA within the one or more COAs, to a CC within the one or more CCs;
storing the request, by a request queue, wherein the request queue is within the CC;
checking the request, wherein the checking is based on one or more additional requests;
translating, by the CC, the request, wherein the translating results in a converted request, wherein the converted request is based on a second communications protocol, and wherein the translating is based on the checking; and
transmitting, by the CC, the converted request to the target device.

23. A computer system for sharing data comprising:
a memory which stores instructions;
one or more processors coupled to the memory, wherein the one or more processors, when executing the instructions which are stored, are configured to:
access a system-on-chip (SoC), wherein the SoC includes a mesh network and one or more coherency ordering agents (COAs), wherein the one or more COAs coordinate coherency for one or more processors coupled to the mesh network, and wherein the one or more COAs are coupled to one or more communication converters (CCs) by the mesh network;
send, by a processor within the one or more processors, a request to a target device, wherein the request is based on a first communications protocol, wherein the request includes a memory address, and wherein the request is sent, by a COA within the one or more COAs, to a CC within the one or more CCs;
store the request, by a request queue, wherein the request queue is within the CC;
check the request, wherein the checking is based on one or more additional requests;
translate, by the CC, the request, wherein the translating results in a converted request, wherein the converted request is based on a second communications protocol, and wherein the translating is based on the checking; and
transmit, by the CC, the converted request to the target device.
